(19) United States
(12) Patent Application Publication
(10) Pub. No.: US 2010/0185457 A1
(43) Pub. Date: Jul. 22, 2010

(54) NERVE-SPECIFIC ELECTRODE (NSE) STUDY PRICING MODEL, AND METHOD AND APPARATUS FOR IMPLEMENTING THE SAME

(76) Inventors: Shai N. Gozani, Brookline, MA (US); David McNamara, Acton, MA (US)

Correspondence Address: Mark J. Pandiscio;Pandiscio & Pandiscio, P.C., 470 Totten Pond Road, Waltham, MA, 02451-1914, US

(21) Appl. No.: 12/557,207

(22) Filed: Sep. 10, 2009

Related U.S. Application Data
(60) Provisional application No. 61/095,836, filed on Sep. 10, 2008.

(51) Int. Cl. G06Q 30/00; G06Q 10/00; G06Q 50/00

(52) U.S. Cl. 705/2

(57) ABSTRACT

A method for computing the amount of a payment which is to be made by a customer and communicating the same, the method comprising establishing a list price for each of a plurality of nerve-specific electrodes (NSEs); establishing a study pricing structure for the NSEs which are to be used in a nerve conduction study (NCS); upon completion of an NCS, determining the number and type of NSEs that were used in that NCS; summing the list prices for each of the NSEs used in that NCS so as to calculate an inventory price; determining the relevant level of the study pricing structure according to the quantity of NSEs used in that NCS so as to determine the appropriate study price; calculating a study pricing credit; determining the amount due; applying the study pricing credit, against the amount due; and displaying the result to the customer.

### REFERENCE TO PENDING PRIOR PATENT APPLICATION

This patent application claims benefit of pending prior U.S. Provisional Patent Application Ser. No. 61/095,836, filed Sep. 10, 2008 by Shai N. Gozani et al. for NERVE-SPECIFIC ELECTRODE STUDY PRICING MODEL (Attorney's Docket No. NEURO-37 PROV), which patent application is hereby incorporated herein by reference.

### FIELD OF THE INVENTION

This invention relates to pricing models in general, and more particularly to pricing models for the sale of diagnostic devices which are used to conduct nerve conduction studies (NCS), and to methods and apparatus for implementing the same.

### BACKGROUND OF THE INVENTION

Nerve conduction studies (NCS) are frequently performed on patients in order to detect and evaluate focal and systemic neuropathies of peripheral nerves and the spinal nerve roots. By way of example but not limitation, Carpal Tunnel Syndrome (CTS) is a very common focal neuropathy caused by compression of the median nerve at the wrist. Symptoms of mild CTS include wrist pain, tingling and numbness, while severe CTS can result in the inability to use one's hand. NCS are now widely used to detect the existence of CTS and to determine its severity.

NCS can be used to evaluate both motor nerve fibers (which control muscle action) and sensory nerve fibers (which provide sensory information to the nervous system).

In an NCS to evaluate motor nerve fibers, the motor nerve is electrically stimulated and the function of the motor nerve fibers are assessed by measuring the electrical response of the muscle which is innervated by the stimulated nerve. In an NCS to evaluate sensory nerve fibers, the sensory nerve is electrically stimulated and the function of the sensory nerve fibers are assessed by measuring the response of those same nerve fibers at a fixed distance from the point of stimulation, or at a known anatomical site remote from the point of stimulation.

One or more electrodes are typically used to apply the aforementioned electrical stimulation to the nerve which is being assessed and to detect the resulting electrical response. In practice, it is generally preferable to use a single, disposable nerve-specific electrode (NSE) device, which includes a plurality of individual electrodes, to both apply electrical stimulation to the nerve and to detect the resulting electrical response. These NSEs generally vary in their specific configuration according to the particular anatomy with which they are to be used. Thus, one configuration of NSE might be used to assess the function of the median nerve, whereas another configuration of NSE might be used to assess the function of the ulnar nerve, etc. See, for example, FIGS. 1-7, which show NSEs used to assess the function of the median nerve (motor/sensory, wrist), the ulnar nerve (motor/sensory, wrist), the ulnar nerve (elbow stimulation), the peroneal nerve, the tibial nerve, the sural nerve and the superficial peroneal nerve, respectively. FIGS. 8 and 9 show two such NSEs applied to a patient. The NSEs shown in FIGS. 1-9 are all commercially available from NeuroMetrix, Inc. of Waltham, Mass., USA.

NSEs have traditionally been priced on a per unit basis, i.e., on a “per NSE” basis. However, some diagnostic studies may require the use of multiple NSEs, whereas other diagnostic studies may only require the use of a single NSE. As a result, the inventors have now recognized that it may sometimes be desirable to price the NSEs on a per diagnostic study basis (i.e., on a “per study” basis), rather than on the traditional “per NSE” basis. Furthermore, the inventors have also recognized that such a per study pricing structure must be both flexible yet meet stringent healthcare compliance standards.

The present invention provides a novel nerve-specific electrode (NSE) study pricing model which addresses the foregoing needs, and a novel method and apparatus for implementing the same.

### SUMMARY OF THE INVENTION

The present invention comprises a novel nerve-specific electrode (NSE) study pricing model, and a novel method and apparatus for implementing the same. Significantly, and as will hereinafter be discussed in detail, this novel study pricing model is a “credits-based” pricing model for use in pricing the NSEs used in nerve conduction studies (NCS).

In one form of the invention, there is provided a method for computing the amount of a payment which is to be made by a customer for the acquisition of new product and communicating the same to the customer, the method comprising:

establishing a list price for each of a plurality of nerve-specific electrodes (NSEs), and recording the same;

establishing a study pricing structure for the NSEs which are to be used in a nerve conduction study (NCS), wherein the study pricing structure comprises a plurality of study pricing levels, and wherein each study pricing level relates a quantity of NSEs to a study price, study price$, and recording the same;

upon completion of an NCS, determining the number and type of NSEs that were used in that NCS, and recording the same;

summing the list prices for each of the NSEs used in that NCS so as to calculate an inventory price, inventory price$, and recording the same;

determining the relevant level of the study pricing structure according to the quantity of NSEs used in that NCS so as to determine the appropriate study price, study price$, and recording the same;

calculating a study pricing credit, credit$, using the equation

credit$=inventory price$−study price$

and recording the same;

determining the amount due for new product sought by the customer;

applying the study pricing credit, credit$, against the amount due for the acquisition of new product, and recording the result; and

displaying the result to the customer.

In another form of the present invention, there is provided an apparatus for computing the amount of a payment which is to be made by a customer for the acquisition of new product and communicating the same to the customer, the apparatus comprising:

means for establishing a list price for each of a plurality of nerve-specific electrodes (NSEs), and recording the same;

means for establishing a study pricing structure for the NSEs which are to be used in a nerve conduction study (NCS), wherein the study pricing structure comprises a plurality of study pricing levels, and wherein each study pricing level relates a quantity of NSEs to a study price, study price$, and recording the same;

means for determining, upon completion of an NCS, the number and type of NSEs that were used in that NCS, and recording the same;

means for summing the list prices for each of the NSEs used in that NCS so as to calculate an inventory price, inventory price$, and recording the same;

means for determining the relevant level of the study pricing structure according to the quantity of NSEs used in that NCS so as to determine the appropriate study price, study price$, and recording the same;

means for calculating a study pricing credit, credit$, using the equation

credit$=inventory price$−study price$

and recording the same;

means for determining the amount due for new product sought by the customer;

means for applying the study pricing credit, credit$, against the amount due for the acquisition of new product, and recording the result; and

means for displaying the result to the customer.

### BRIEF DESCRIPTION OF THE DRAWINGS

These and other objects and features of the present invention will be more fully disclosed in the following detailed description of the preferred embodiments of the invention, which is to be considered together with the accompanying drawings wherein:

FIG. 1 is a schematic view of an NSE used to assess the function of the median nerve (motor/sensory, wrist);

FIG. 2 is a schematic view of an NSE used to assess the function of the ulnar nerve (motor/sensory, wrist);

FIG. 3 is a schematic view of an NSE used to assess the function of the ulnar nerve (elbow stimulation);

FIG. 4 is a schematic view of an NSE used to assess the function of the peroneal nerve;

FIG. 5 is a schematic view of an NSE used to assess the function of the tibial nerve;

FIG. 6 is a schematic view of an NSE used to assess the function of the sural nerve;

FIG. 7 is a schematic view of an NSE used to assess the function of the superficial peroneal nerve;

FIGS. 8 and 9 are schematic views showing NSEs applied to a patient;

FIG. 10 is a schematic view of an exemplary “Study Pricing Agreement” which will hereinafter be discussed in further detail;

FIGS. 11A-11C are schematic views of a “Study Pricing Monthly Statement” which will hereinafter be discussed in further detail;

FIG. 12 is a flowchart illustrating the operation of the novel nerve-specific electrode (NSE) study pricing model of the present invention; and

FIG. 13 shows two exemplary study pricing programs.

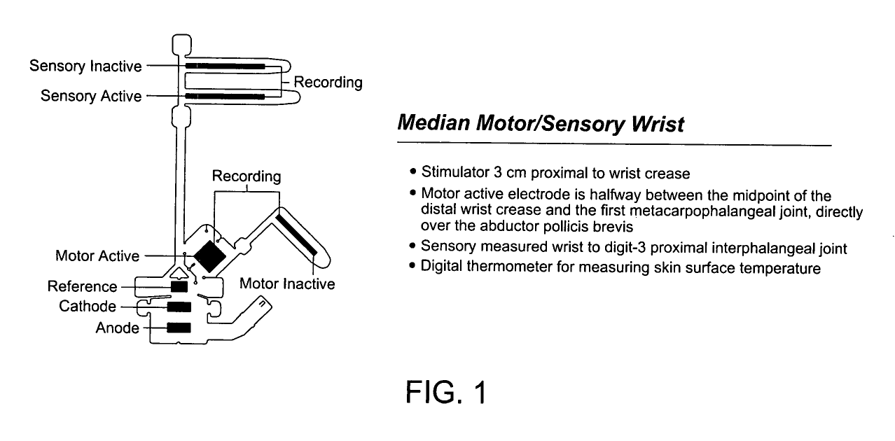

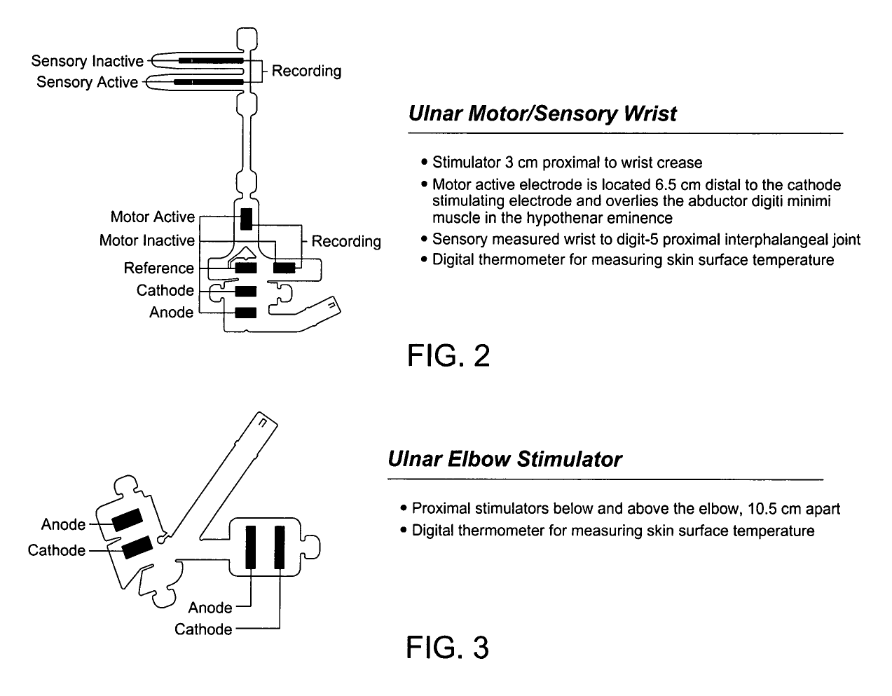

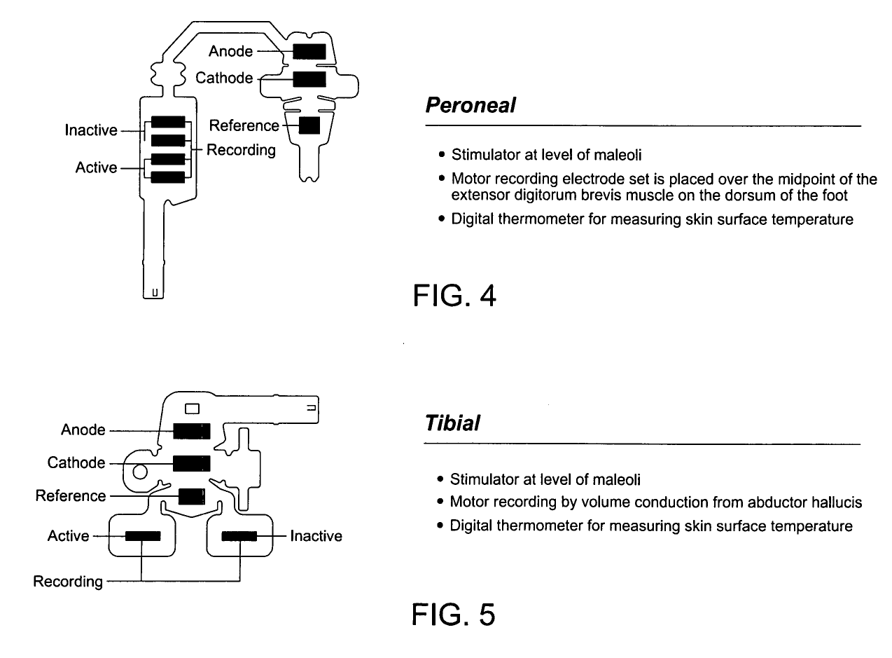

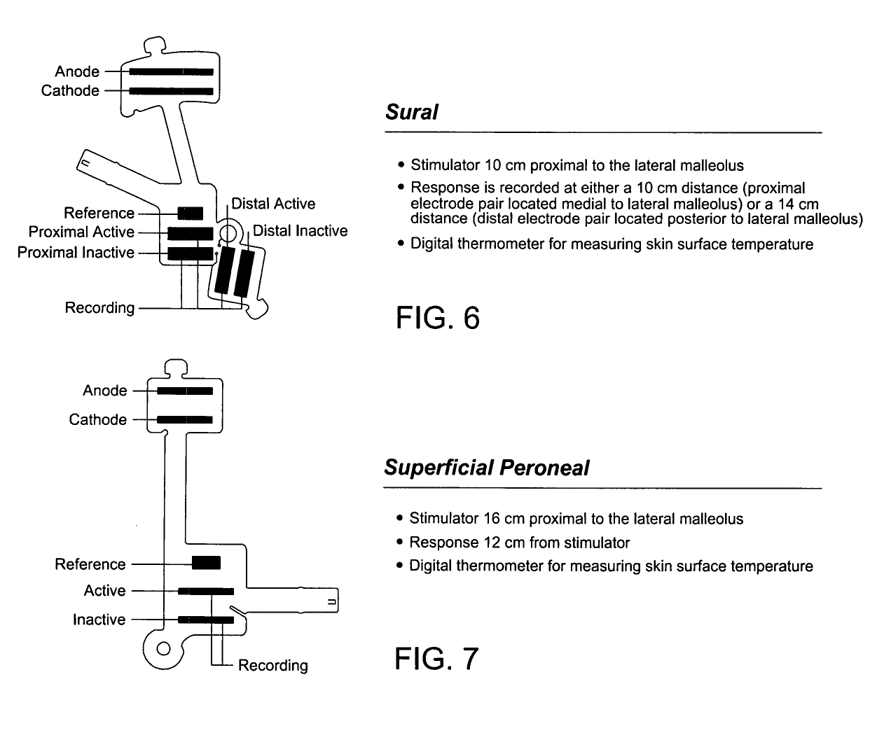

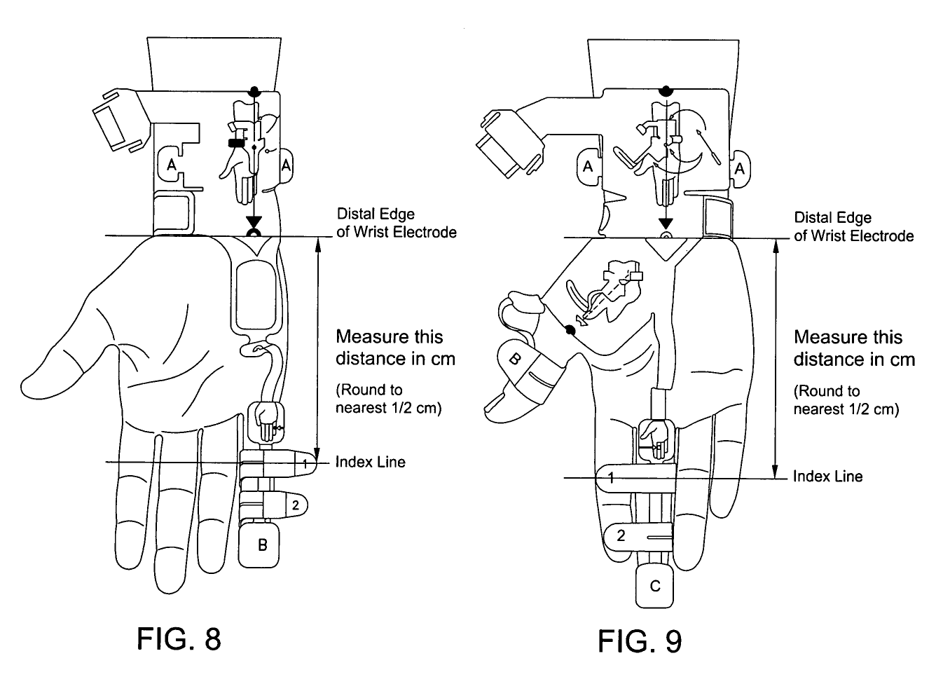

### DETAILED DESCRIPTION OF THE INVENTION

The present invention comprises a novel nerve-specific electrode (NSE) study pricing model, and a novel method and apparatus for implementing the same. Significantly, and as will hereinafter be discussed in detail, this novel study pricing model is a “credits-based” pricing model for use in pricing the NSEs used in nerve conduction studies (NCS).

The study pricing model is preferably implemented in the following manner.

### Study Pricing Agreement

Before study pricing is implemented for a customer, the customer must sign an agreement (the “Study Pricing Agreement”) that describes the study pricing process and establishes study pricing levels.

The study pricing agreement is preferably as follows:
a single page;
it includes signature lines at the bottom of the page for the customer and an authorized account representative to indicate their mutual acceptance of the terms of the study pricing agreement;
it includes a statement that customers must purchase NSEs at standard list prices;
it specifies a study pricing structure for the study pricing agreement—the study pricing structure essentially comprises a plurality of Study Pricing Levels (SPL) (in $) for each of a number of different NSE quantity ranges, and the study price (“study price$”) associated with that quantity of NSEs, e.g.:
   Study Pricing Level 1
   1-4 NSEs used in a study: study price$=X (e.g., study price$=$68.00)
   Study Pricing Level 2
   5-7 NSEs used in a study: study price$=Y (e.g., study price$=$88.00)
   Study Pricing Level 3
   8+ NSEs used in a study: study price$=Z (e.g., study price$=$108.00)
      (the foregoing ranges, quantities, and prices are provided above merely as an example—additional ranges, quantities, and study pricing levels are contemplated by the present invention);
it includes a description of the study pricing model in which, when a study is performed, the customer receives study pricing credits (“credit$”) for the difference between the sum of the list prices for each of the NSEs used in that study (“inventory price$”) and the study price, study price$—these credits may be used to offset the cost of future orders of NSEs—hence it will be seen that the study pricing model of the present invention comprises a “credits-based” pricing model;
it includes a statement that study pricing credits are not transferrable and cannot be redeemed for cash;
it includes a statement that unused study pricing credits will expire a fixed time (e.g., 1 year) after they are issued;
it includes a statement that there are no additional discounts or alternative pricing plans allowed;
it includes a statement that nothing in the program is intended to maximize third party reimbursement;
it includes a start date for study pricing; and
it includes an end date for study pricing (the end date may be unspecified if desired).

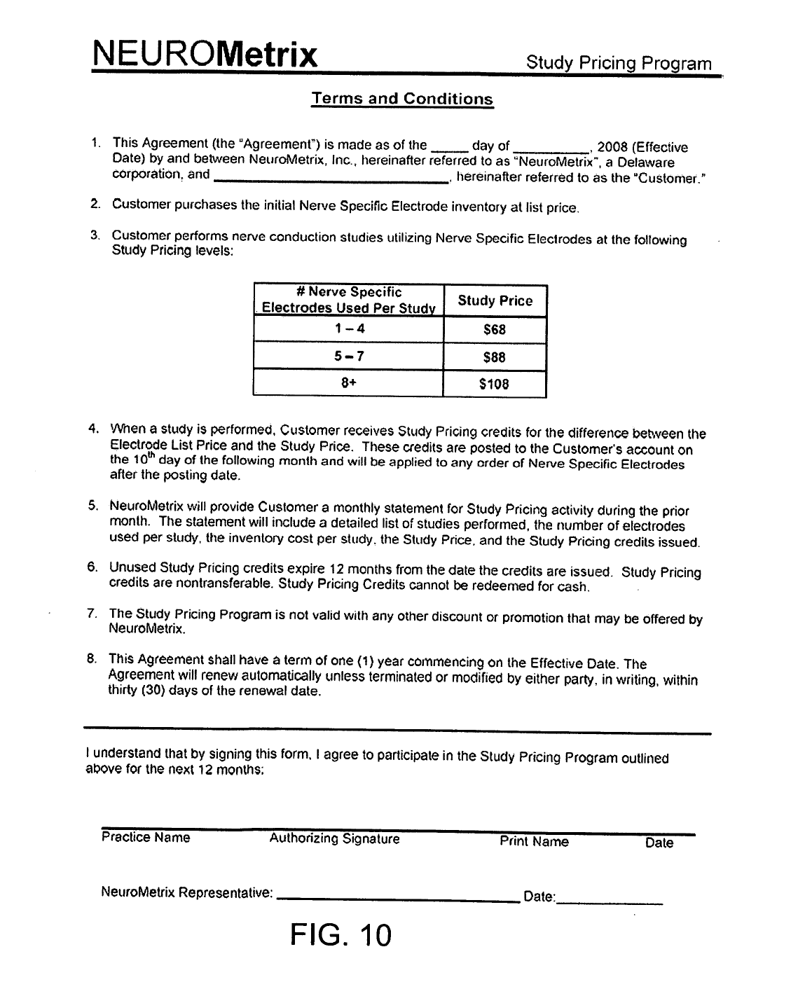

See, for example, FIG. 10, which illustrates an exemplary study pricing agreement.

Study pricing agreements are sent to customer service after they have been signed by the customer and an authorized account representative. Customer service ensures that the study pricing agreements are completely filled in and that everything is in order. Customer service also ensures that appropriate internal corporate approvals are obtained, based on an approval matrix established by the company. Customer service enters the study pricing parameters into the customer's records.

### Study Pricing Operation

The study pricing of the present invention preferably operates as follows.

First, the customer enters into a study pricing agreement as described above. Among other things, and as noted above, the study pricing agreement establishes the study pricing levels for the study pricing program. The study pricing is preferably tied to the customer via Customer IDs.

Next, a credit (i.e., credit$) is calculated for any study conducted after the study pricing start date. The credit is calculated as follows. First, the list price of each of the valid NSEs used in the study (i.e., “inventory price$”) is summed. For example, where a single bilateral median NSE and a single ulnar motor/sensory NSE are used in a study, and where the list price of the bilateral median NSEs is $60 and the list price of the ulnar motor/sensory NSEs is $120, then the inventory price$ would be $180. Then the credit$ is calculated as follows:

credit$=inventory price$−study price$

where study price$ is determined by the number of NSEs used in the study, e.g., as specified in the Study Pricing Levels in the Study Pricing Agreement (see above). By way of example but not limitation, if a study required the use of 6 NSEs each having a list price of $30, for a total extended list price (i.e., inventory price$) of $180, and if the study price (i.e., study price$) for that number of NSEs is $88, the customer would generate a credit (i.e., credit$) of $180−$88, or $92, for use in the next purchase of NSEs.

Credits are preferably calculated and issued on a monthly basis. More particularly, the credits are preferably calculated and issued for the prior month on the first business day following the 10^{th} day of the following month. The credits are calculated and made available automatically. Customer service and accounting then automatically apply all available study pricing credits to a customer's next order at the time it is received. The value of credits which have expired according to the terms of the study pricing agreement is excluded from the customer's credit balance.

A reconciliation statement (also known as a “Study Pricing Monthly Statement”) is preferably sent out to the customer (e.g., by E-mail, fax, etc.) on the first business day following the 10^{th} day of each month for the prior month. The reconciliation statement preferably provides the following information to the customer:
one entry is provided on the statement for each study performed during the prior month (assuming that the study was performed after the study pricing start date), and the statement entry for each study preferably includes the following information: (i) Study Date, (ii) Patient ID, (iii) Study ID, (iv) a list of all NSEs used in the study (including serial number, item description, and list price for each NSE listed) (v) inventory price$, (vi) credit$, and (vii) study price$;
total inventory used (based on unit list price) for the month;
total credits issued for the month;
total study prices (sum of all of the study price$ in the statement);
total previous unexpired credits;
total unexpired credits consumed as of a statement period end date;
total credits available as of a statement period end date; and
appropriate discount disclosures on the reconciliation statement.

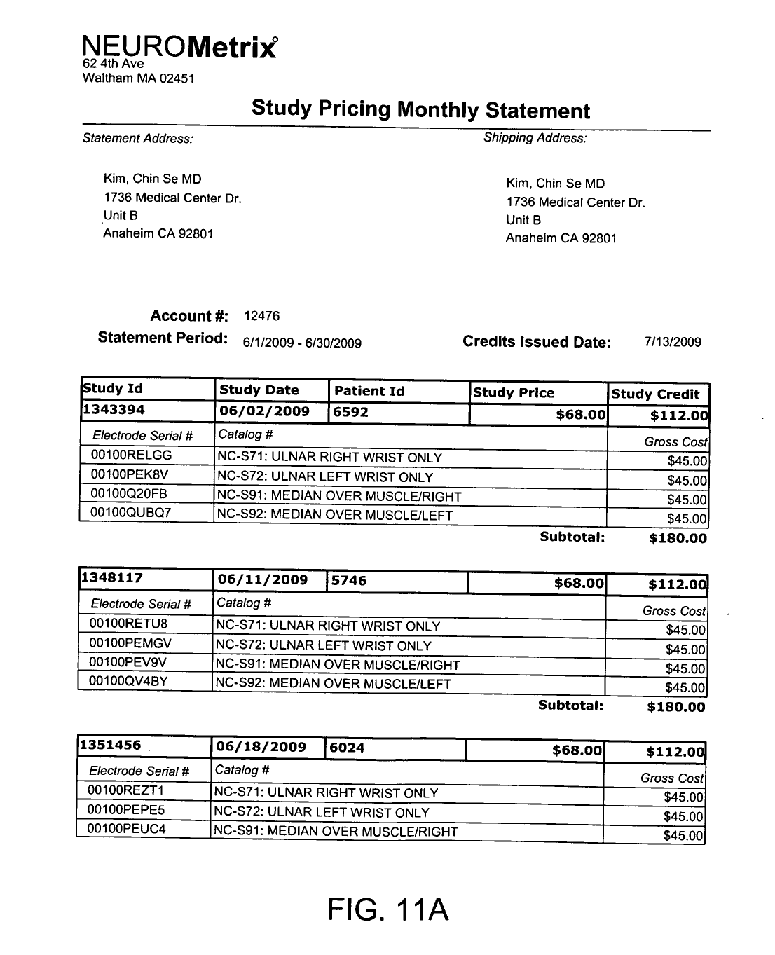

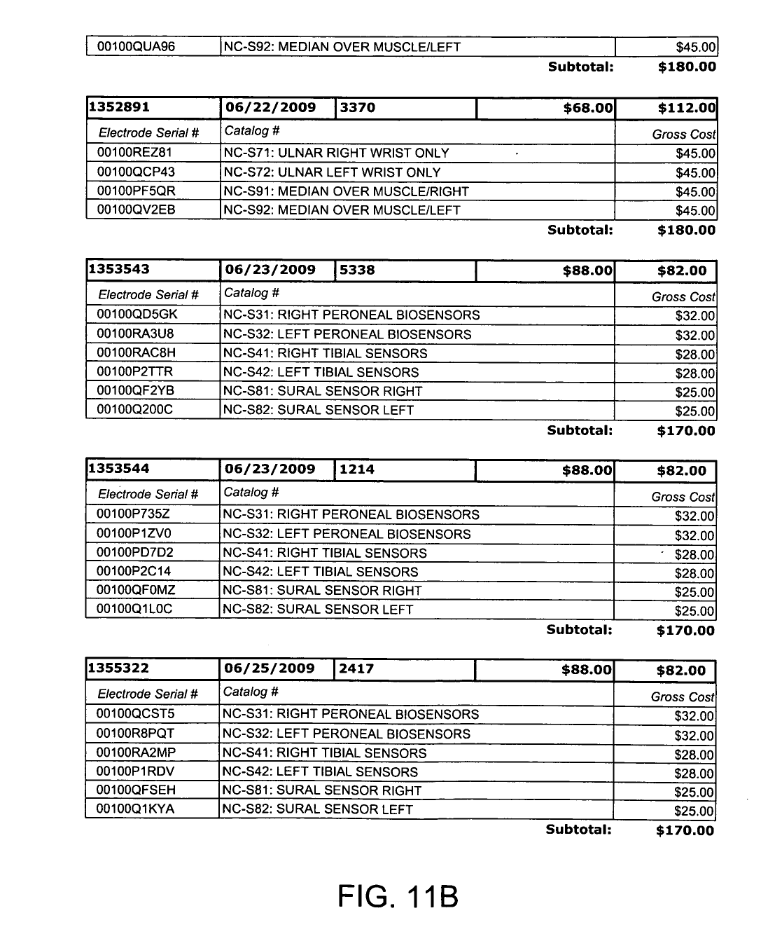

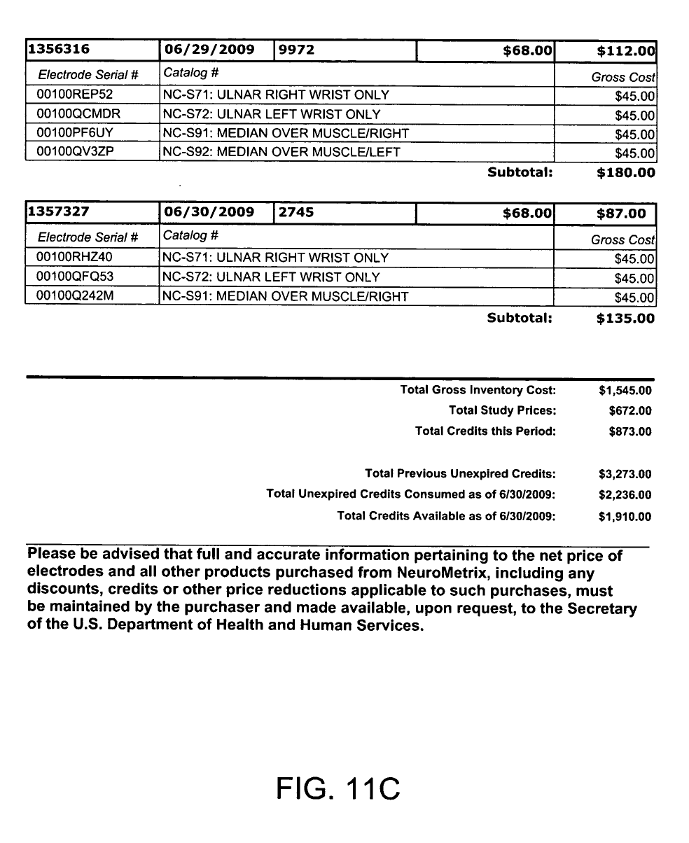

See FIGS. 11A-11C for an exemplary “Study Pricing Monthly Statement”.

The foregoing study pricing model is preferably implemented utilizing an appropriately-programmed general purpose computer, server database software (e.g., Microsoft SQL Server), and general accounting system software (e.g., Microsoft Dynamics GP).

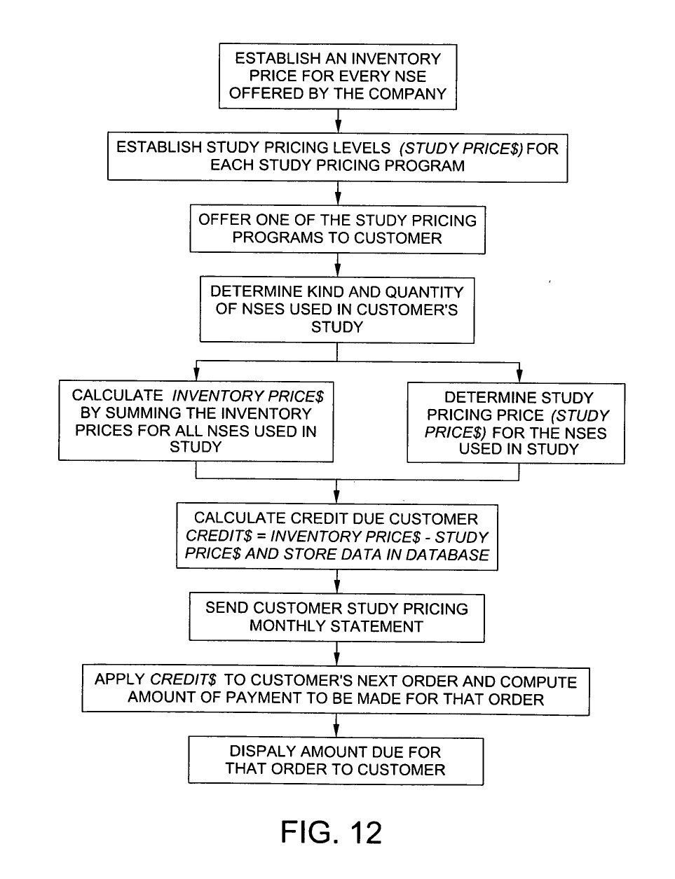

FIG. 12 is a flowchart illustrating the operation of the novel nerve-specific electrode (NSE) study pricing model of the present invention.

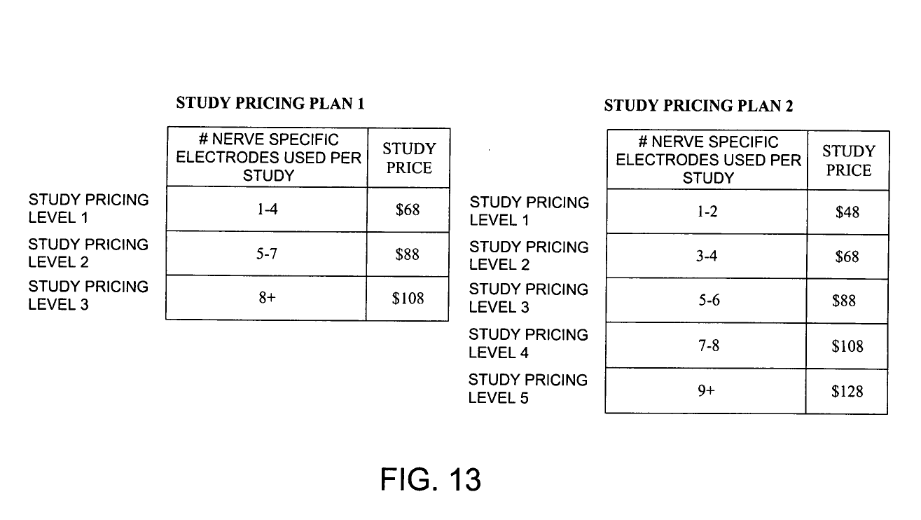

It should be appreciated that multiple study pricing programs, each with its own study pricing structure, may be established by a company. In this case, the company offers an appropriate study pricing structure to its customer and this study pricing structure is recited in the study pricing agreement. See, for example, FIG. 13, which shows two such study pricing programs.

### MODIFICATIONS

It is to be understood that the present invention is by no means limited to the particular constructions herein disclosed and/or shown in the drawings, but also comprises any modifications or equivalents within the scope of the invention.

What is claimed is:

1. A method for computing the amount of a payment which is to be made by a customer for the acquisition of new product and communicating the same to the customer, the method comprising:
establishing a list price for each of a plurality of nerve-specific electrodes (NSEs), and recording the same;
establishing a study pricing structure for the NSEs which are to be used in a nerve conduction study (NCS), wherein the study pricing structure comprises a plurality of study pricing levels, and wherein each study pricing level relates a quantity of NSEs to a study price, study price$, and recording the same;
upon completion of an NCS, determining the number and type of NSEs that were used in that NCS, and recording the same;
summing the list prices for each of the NSEs used in that NCS so as to calculate an inventory price, inventory price$, and recording the same;
determining the relevant level of the study pricing structure according to the quantity of NSEs used in that NCS so as to determine the appropriate study price, study price$, and recording the same;
calculating a study pricing credit, credit$, using the equation
credit$=inventory price$−study price$
and recording the same;
determining the amount due for new product sought by the customer;
applying the study pricing credit, credit$, against the amount due for the acquisition of new product, and recording the result; and
displaying the result to the customer.

2. A method according to claim 1 wherein the new product comprises at least one NSE.

3. A method according to claim 1 wherein the study pricing structure is defined by a written agreement with the customer.

4. A method according to claim 1 wherein the study pricing structure comprises at least 3 levels.

5. A method according to claim 1 wherein the result is displayed in a printed statement provided to the customer.

6. A method according to claim 1 wherein the result is displayed in an email statement provided to the customer.

7. A method according to claim 1 wherein the result is displayed in a fax statement provided to the customer.

8. A method according to claim 1 wherein a study pricing credit cannot be redeemed for cash.

9. A method according to claim 1 wherein a study pricing credit expires after a pre-determined period of time.

10. A method according to claim 1 wherein a study pricing credit is not transferable to another customer.

11. Apparatus for computing the amount of a payment which is to be made by a customer for the acquisition of new product and communicating the same to the customer, the apparatus comprising:
means for establishing a list price for each of a plurality of nerve-specific electrodes (NSEs), and recording the same;
means for establishing a study pricing structure for the NSEs which are to be used in a nerve conduction study (NCS), wherein the study pricing structure comprises a plurality of study pricing levels, and wherein each study pricing level relates a quantity of NSEs to a study price, study price$, and recording the same;
means for determining, upon completion of an NCS, the number and type of NSEs that were used in that NCS, and recording the same;
means for summing the list prices for each of the NSEs used in that NCS so as to calculate an inventory price, inventory price$, and recording the same;
means for determining the relevant level of the study pricing structure according to the quantity of NSEs used in that NCS so as to determine the appropriate study price, study price$, and recording the same;
means for calculating a study pricing credit, credit$, using the equation
credit$=inventory price$−study price$
and recording the same;
means for determining the amount due for new product sought by the customer;
means for applying the study pricing credit, credit$, against the amount due for the acquisition of new product, and recording the result; and
means for displaying the result to the customer.

12. Apparatus according to claim 11 wherein the new product comprises at least one NSE.

13. Apparatus according to claim 11 wherein the study pricing structure is defined by a written agreement with the customer.

14. Apparatus according to claim 11 wherein the study pricing structure comprises at least 3 levels.

15. Apparatus according to claim 11 wherein the result is displayed in a printed statement provided to the customer.

16. Apparatus according to claim 11 wherein the result is displayed in an email statement provided to the customer.

17. Apparatus according to claim 11 wherein the result is displayed in a fax statement provided to the customer.

18. Apparatus according to claim 11 wherein a study pricing credit cannot be redeemed for cash.

19. Apparatus according to claim 11 wherein a study pricing credit expires after a pre-determined period of time.

20. Apparatus according to claim 11 wherein a study pricing credit is not transferable to another customer.
